(19) United States
(12) Patent Application Publication
(10) Pub. No.: US 2011/0169952 A1
(43) Pub. Date: Jul. 14, 2011

(54) VIDEO DATA PROCESSING DEVICE AND VIDEO DATA PROCESSING SYSTEM

(76) Inventors: Kohei Yamaguchi, Nara (JP); Takahisa Fujita, Osaka (JP); Yasunori Satoh, Aichi (JP)

(21) Appl. No.: 13/063,531

(22) PCT Filed: Jul. 27, 2010
(86) PCT No.: PCT/JP2010/004757

§ 371 Date: Mar. 11, 2011

(30) Foreign Application Priority Data
Jul. 31, 2009 (JP) 2009-179342

(51) Int. Cl. H04N 7/18

(52) U.S. Cl. 348/143; 348/E07.085

(57) ABSTRACT

When a main video data stream that is selected and decoded is changed, a video data processing device 101 instructs, via a network 110, a surveillance camera that encodes a newly-selected main video data stream to create a main video data stream with a smaller I-frame interval as of that point, and instructs, via a network 110, a surveillance camera that encodes a newly-deselected main video data stream to create a main video data stream with a larger I-frame interval as of that point.

### TECHNICAL FIELD

The present invention relates to a video data processing device that receives encoded data streams from a plurality of encoding devices, and selects as well as outputs one data stream among the received encoded data streams for display or recording.

### BACKGROUND ART

In recent years, surveillance camera systems in which a plurality of surveillance cameras and a video data processing device are connected via a network so as to allow a user to perform surveillance through video data received by the video data processing device from the surveillance cameras by have become widespread.

In such a surveillance camera system, in order to constrain the transfer rate of data over the network, each of the surveillance cameras encodes video footage in real time using an encoding method based on MPEG (Moving Picture Experts Group) standards (hereinafter referred to as MPEG format), the size of data is compressed per unit time, and only then is the encoded video data stream transmitted to the video data processing device.

Video data streams encoded in MPEG format consist of a group of frames. Each of these frames is one of three types: I-frames (Intra-coded frames), P-frames (Predicted frames), and B-frames (Bi-directional predicted frames).

I-frames are encoded solely according to intra-frame data and thus do not depend on any other frames. P-frames and B-frames are encoded according to inter-frame data differences.

In contrast to P-frames and B-frames, I-frames have a characteristically larger data size. Thus, if the frame rate is fixed, then the data size per unit time of encoded video data streams is smaller when there is a smaller number of I-frames per unit time, or in other words, when the I-frame interval is larger. The data size per unit time of encoded video data streams is correspondingly larger when the I-frame interval is smaller.

When encoding in MPEG format, the I-frame interval can be modified. As such, the point has been made that the data size per unit time of encoded video data streams can in turn be modified. Thus, technology for encoding while modifying the I-frame interval in response to load on the network that transmits the streams so encoded has been proposed (such as Patent Literature 1).

### [Citation List]

### [Patent Literature]

[Patent Literature 1]
   Japanese Patent Application Publication No. 2009-49577

### SUMMARY OF INVENTION

### [Technical Problem]

Given that I-frames can be decoded without reliance on data from other frames, decoding of a video data stream encoded in MPEG format can be correctly initiated when the first frame to be decoded is an I-frame. However, when the first frame to be decoded is a P-frame or a B-frame, decoding cannot be correctly initiated should the reference frames on which such frames rely not be present in the data.

Accordingly, in a surveillance camera system in which multiple surveillance cameras transmit video data streams encoded in MPEG format in real time and one selected video data stream among these is decoded and displayed in real time, and which does not store data from non-selected video data streams, although fast video data stream changeover is desired, correct decoding of the changeover destination stream cannot be initiated without first waiting for an I-frame thereof to be transmitted.

For instance, suppose that the user is performing surveillance using the video data processing device to which multiple surveillance cameras are connected via a network. While watching video footage from one camera, the user spies suspicious movement by a prowler and immediately changes the footage over to footage from another camera at a different angle in an attempt to investigate this movement in more detail. Nevertheless, changeover cannot occur until an I-frame comes into position in the video from the other camera, which is a problem in itself, and presents a further problem in the possibility that suspicious movement may be missed in the span of time required for video changeover.

In order to solve this problem, the I-frame interval of the video data streams must be reduced for all of the surveillance cameras that may be switched over to next.

However, considering that simply reducing the I-frame interval results in greater data size per unit time in the video data streams transmitted by each of the surveillance cameras that may be switched over to next, the transfer bit rate over the network that transmits the streams grows and the data size per unit time that must be received by the video data processing device ultimately exceeds the maximum transfer rate of data of the network. This causes a new problem in the possibility that the video data processing device may be unable to correctly receive the video data streams.

The present invention has been achieved in view of the above problems, and an aim thereof is to provide a video data processing device for realizing a surveillance camera system that takes video data streams encoded in MPEG format and that is able to change between video data streams from surveillance cameras in a brief interval while constraining the transfer bit rate of data over the network.

### [Solution to Problem]

In order to solve the above problems, the video data processing device of the present invention comprises a data reception unit operable to receive encoded data streams that include I-frames and that are transmitted in parallel from a plurality of encoding devices that encode and transmit video data, a selection unit operable to select and output one of the encoded data streams received in parallel by the data reception unit, an interval instruction unit operable, when the selected encoded data stream is changed from a first encoded data stream over to a second encoded data stream, to instruct an encoding device that encodes and transmits the first encoded data stream to begin encoding with a smaller I-frame time interval than that previously used thereby, and to instruct an encoding device that encodes and transmits the second encoded data stream to begin encoding with a larger I-frame time interval than that previously used thereby, and a data size instruction unit operable, when a size per unit time of data received by the data reception unit is above an upper threshold, to instruct any one or more of the encoding devices transmitting non-selected encoded data streams to change a quantization table currently in use for I-frame quantization over to a quantization table for which an encoded size of video data encoded therewith is smaller than that of the quantization table currently in use.

### [Advantageous Effects of Invention]

According to the video data processing device pertaining to the present invention with the above-described structure, a surveillance camera system that takes video data streams encoded in MPEG format can be realized in which the transfer bit rate of data over the network is constrained while changeover between video data streams from different cameras is performed in a brief interval.

### BRIEF DESCRIPTION OF FIGURES

FIG. 1 is a configuration diagram showing the outline of the video data processing system 1000.

FIG. 2 is a configuration diagram showing the configuration of surveillance camera A 111.

FIG. 3 is a structural diagram showing the structure of the quantization tables.

FIG. 4 is a first structural diagram showing the general data structure of the main video data stream.

FIG. 5 is a second structural diagram showing the general data structure of the main video data stream.

FIG. 6 is a configuration diagram showing a portion of the configuration of the encode unit 212.

FIG. 7 is a configuration diagram showing the configuration of the video data processing device 101.

FIG. 8 is a flowchart showing the operations of the video data processing device 101 at selected video changeover time.

FIG. 9 is a flowchart showing the operations of surveillance cameras A 111 through D 114 at selected video changeover time.

FIG. 10 is a data structure diagram showing the general data structure of the four main video data streams.

FIG. 11 is a data structure diagram showing the general data structure of the main video data stream decoded by the data decode unit 707.

FIG. 12 is a flowchart showing the operations of the video data processing device 101 when the received data rate fluctuates.

FIG. 13 is a flowchart showing the operations of surveillance cameras A 111 through D 114 when the received data rate fluctuates.

FIG. 14 is a received data rate process diagram showing the data rate received by the data reception unit 703.

FIG. 15 is a data structure diagram showing the general data structure of the four main video data streams.

FIG. 16 is a structural diagram showing the structure of the video data processing device 1600.

### DESCRIPTION OF EMBODIMENT

### Embodiment

An embodiment of the video data processing system that uses the video data processing device of the present invention is described below. As such, four surveillance cameras (serving as encoding devices) are connected through a network to the video data processing device so as to allow a user to perform surveillance based on the video data received by the video data processing device from the surveillance cameras.

### (Configuration)

### {System Outline}

First, the outline of the video data processing system that uses the video data processing device pertaining to the present invention is described with reference to the figures.

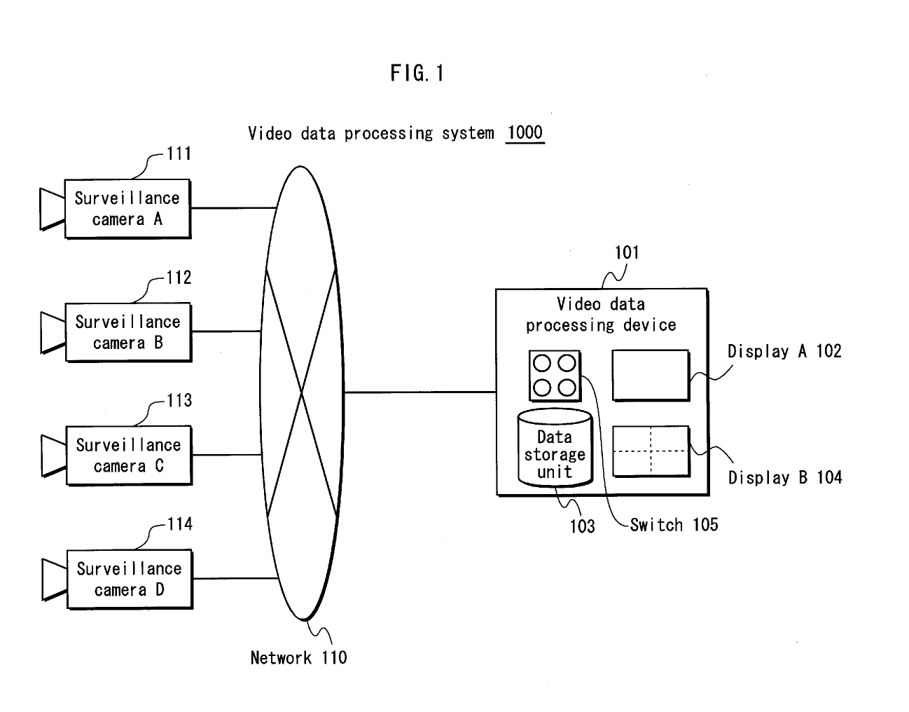

FIG. 1 is a general configuration diagram showing the outline of the video data processing system 1000 pertaining to the present Embodiment. The video data processing system 1000 comprises surveillance camera A 111, surveillance camera B 112, surveillance camera C 113, surveillance camera D 114, a video data processing device 101, and a network 110.

Surveillance cameras A 111 through D 114 are arranged at every corner of a passageway, such as a hotel hallway, with the aim of capturing surveillance video footage. The captured footage is encoded in real time using an encoding method based on the MPEG4-AVC (Advanced Video Coding) standard (hereinafter referred to as MPEG4-AVC format) into an encoded data stream. The encoded data stream (hereinafter referred to as main video data stream) is then transmitted to the video data processing device 101 via the network 110.

Each surveillance camera A 111 through D 114 can modify the time interval between I-frames of the main video data stream (hereinafter simply referred to as “I-frame interval”) encoded thereby, as well as change the quantization table in use for I-frame quantization.

The video data processing device 101 takes a selected one of the main video data streams out of the four main video data streams transmitted via the network 110 from surveillance cameras A 111 through D 114, saves the selected stream in a data storage unit 103 while simultaneously decoding the stream in real time, and displays the decoded video footage on display A 102.

The video footage displayed on display A 102 is at a resolution similar to that of NTSC (National Television System Committee) signals used by home television sets.

To change over between selected main video data streams for decoding, the video data processing device 101 instructs the surveillance camera that encodes the newly-deselected main video data stream to begin encoding with a smaller I-frame interval as of that point. The video data processing device 101 also instructs the surveillance camera that encodes the newly-selected main video data stream to begin encoding with a larger I-frame interval as of that point. These instructions are made via the network 110.

The surveillance camera that transmits the newly-deselected encoded data is instructed to make the I-frame interval smaller for the following reason: Given that the video data processing device 101 does not retain non-selected encoded data, if no frames before the decoding initialization frame are retained, then proper decoding of a main video data stream that is encoded in MPEG4-AVC format cannot begin without waiting until an I-frame is the decoding initialization frame. Therefore, there is a need to decrease the I-frame interval in any main video data stream which might be changed over to next in order to reduce the waiting time between the reception of a main video data stream changeover request and the appearance of the next I-frame.

The surveillance camera that transmits the newly-selected encoded data is instructed to make the I-frame interval larger for the following reason: There is no possibility that the newly-selected surveillance camera will be changed over to next, and so the rationale for decreasing the I-frame interval, namely the reduction of waiting time until the next I-frame, disappears. On the contrary, the size of the encoded data can be reduced by increasing the I-frame interval.

The user (not diagrammed) is able to change the video footage displayed on display A 102 from the currently-displayed footage over to footage captured by a different surveillance camera by operating the switch 105 of the video data processing device 101.

Additionally, surveillance cameras A 111 through D 114 encode, in real time, captured video footage into an encoded data stream (hereinafter referred to as sub-video data stream) at a data rate that is roughly 1/32 to 1/12 (details explained later) that of the above-described main video data stream and transmit this sub-video data stream to the video data processing device 101 via the network 110.

In order to reduce the data size per unit time of the sub-video data streams, the encoded size thereof is reduced at encoding time. The image quality of the video footage so obtained (hereinafter referred to as sub-video footage) is on the order of QCIF (Quarter Common Intermediate Format) resolution.

The video data processing device 101 decodes the four sub-video data streams received via the network 110 from surveillance cameras A 111 through D 114 in real time, and displays the sub-video footage on display B 104, which is able to display all four simultaneously.

The network 110 transmits the main video data streams and the sub-video data streams output by surveillance cameras A 111 through D 114 to the video data processing device 101 with a wired connection. The network 110 also transmits instruction signals output by the video data processing device 101 concerning encryption methods to surveillance cameras A 111 through D 114 with the wired connection. The maximum data transmission bit rate of the network 110 may be, for example, 50 Mbps.

Through the video data processing system 1000, the user is able to perform surveillance on a hotel passageway as follows: The user watches display B 104, on which are displayed, in real time, four sub-video streams from surveillance cameras A 111 through D 114 at QCIF resolution. The user then selects footage for closer observation by operating the switch 105 which changes the footage displayed at NTSC resolution on display A 102 over to the selected footage. The selected video footage is displayed on display A 102 in real time, and is simultaneously stored in the data storage unit 103.

The details of surveillance cameras A 111 through D 114 and of the video data processing device 101 are explained below, in that order.

### {Surveillance Cameras}

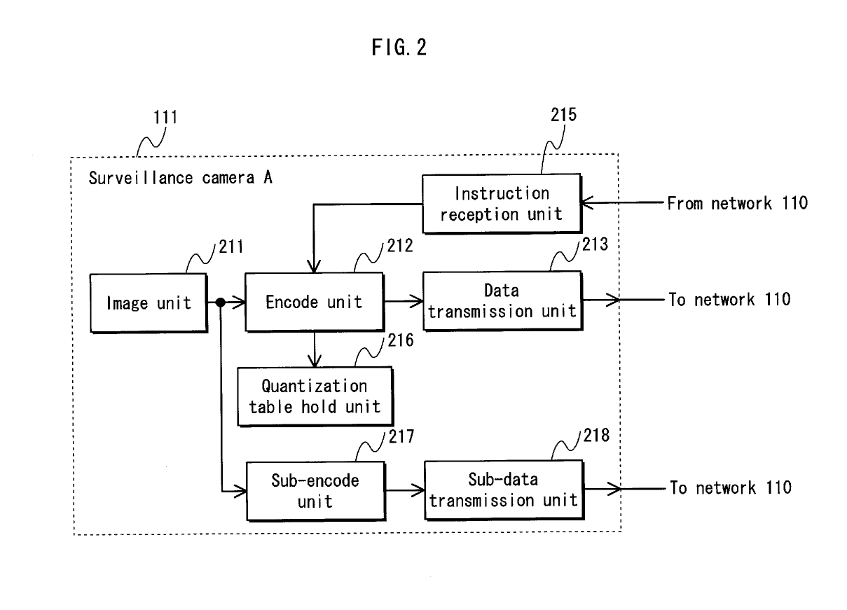

FIG. 2 is a configuration diagram showing the configuration of surveillance camera A 111.

Only the configuration of surveillance camera A 111, taken as a representative example of surveillance cameras A 111 through D 114, is shown and explained below. The respective configuration of surveillance camera B 112, surveillance camera C 113, and surveillance camera D 114 is identical to that of surveillance camera A 111, with all cameras possessing the same capabilities.

Surveillance camera A 111 comprises an image unit 211, an encode unit 212, a data transmission unit 213, an instruction reception unit 215, a quantization table hold unit 216, a sub-encode unit 217, and a sub-data transmission unit 218.

The image unit 211 has two functions. One is to capture video footage as a camera, and the other is to generate digital video data by converting the captured video footage into a digital signal. The generated digital video data is output to the encode unit 212 and the sub-encode unit 217.

The instruction reception unit 215 receives each signal that is transmitted by the video data processing device 101 via the network 110 and outputs the signals to the encode unit 212. The signals for surveillance camera A 111 are as follows: an interval decrease instruction signal with instructions to decrease the I-frame interval of the main video data stream transmitted thereby as of that point; an interval increase instruction signal with instructions to increase the I-frame interval of the main video data stream as of that point; an encoded size reduction instruction signal with instructions to reduce the encoded size of the main video data stream; and an encoded size enlargement instruction signal with instructions to enlarge the encoded size of the main video data stream.

The quantization table hold unit 216 holds a first quantization table and a second quantization table, which are used when the encode unit 212 performs I-frame quantization.

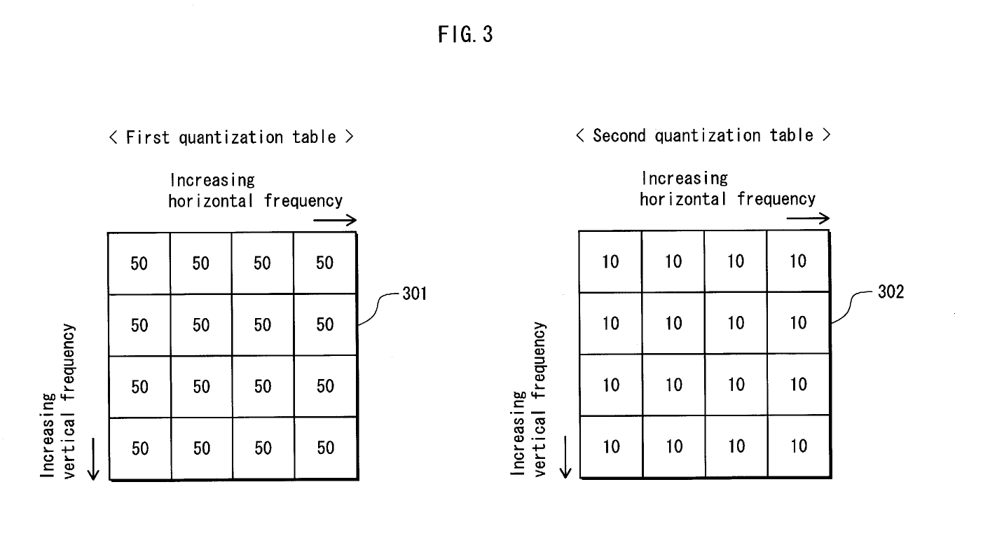

FIG. 3 shows the specific contents of the first quantization table 301 and the second quantization table 302, both of which are held by the quantization table hold unit 216.

Each quantization table comprises 16 quantization steps that correspond to 16 frequency components in a four-by-four matrix of four horizontal frequency components by four vertical frequency components.

Each of the quantization steps that make up the first quantization table 301 has a greater value than the quantization steps of the corresponding frequency components in the second quantization table 302. Thus, the relationship between the first quantization table 301 and the second quantization table 302 is such that the encoded size that results from use of the first quantization table 301 for I-frame quantization is smaller than the encode size that results from use of the second quantization table 302 for same.

The encode unit 212 encodes the digital video data input from the image unit 211 using an encoding method based on the MPEG4-AVC standard, then outputs the encoded main video data stream to the data transmission unit 213.

In response to interval decrease or increase instruction signal input from the instruction reception unit 215, the encode unit 212 encodes the input digital video data into a main video data stream that has one of two I-frame intervals, either producing an I-frame ratio of one to every 15 frames or of one to every three frames. Also, in response to encoded size reduction instruction signals or encoded size enlargement instruction signals input from the instruction reception unit 215, the encode unit 212 performs encoding using either of the quantization tables that are held by the quantization table hold unit 216, namely the first quantization table 301 or the second quantization table 302, for I-frame quantization.

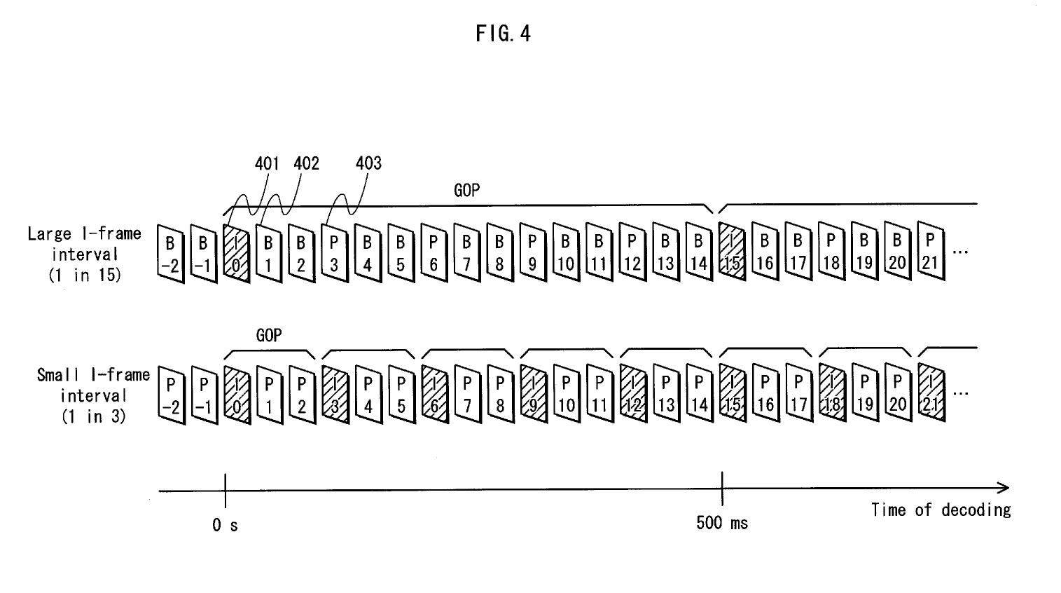

FIG. 4 is a general data structure diagram showing the frames of the main video data stream encoded by the encode unit 212. The main video data stream comprises frames that are decoded and displayed, in the order shown, on display A 102.

In FIG. 4, each rectangle represents a frame. The letters “I”, “P”, and “B” respectively designate each frame as an I-frame, a P-frame, or a B-frame.

The number written in each rectangle indicates the order in which each frame is decoded and displayed on display A 102.

When the encode unit 212 encodes the input digital video data with an I-frame interval producing a ratio of one I-frame to every 15 frames, one GOP (Group of Pictures) then consists of frames in the order I-B-B-P-B-B-P-B-B-P-B-B-P-B-B. This is shown in the top row of FIG. 4, labeled “Large I-frame Interval”. When the I-frame interval produces a ratio of one I-frame to every three frames, the encode unit 212 encodes the data so that one GOP consists of frames in the order I-P-P. This is shown in the bottom row of FIG. 4, labeled “Small I-frame Interval”.

In either case, the input digital video data is encoded so that 15 frames are included in every 500 ms of footage. The frame rate is thus 30 fps.

A P-frame is encoded with reference to the nearest I-frame or P-frame that precedes the frame itself, with respect to display order.

A B-frame is encoded with reference to two frames, namely the nearest I-frame or P-frame that precedes the frame itself and the nearest I-frame or P-frame that follows the frame itself, with respect to display order.

For P-frames and B-frames alike, the reference frames are frames included in the same GOP as the frame itself. Frames not included in the same GOP are never used for reference.

When encoding digital video data using an I-frame interval described above as producing one I-frame to every 15 frames, the encode unit 212 performs encoding in a different order than the display order so that B-frames may be included in the encoded main video data stream.

For example, consider the B-frame 402, which references the I-frame 401 and the P-frame 403. The P-frame 403 references the I-frame 401, and thus the B-frame 402 must be encoded after the I-frame 401 and the P-frame 403 have both been encoded.

In contrast, when encoding digital video data using an I-frame interval described above as producing one I-frame to every three frames, the encode unit 212 performs encoding in the same order as the display order.

This is because no B-frames are included in the encoded main video data stream encoded in this fashion.

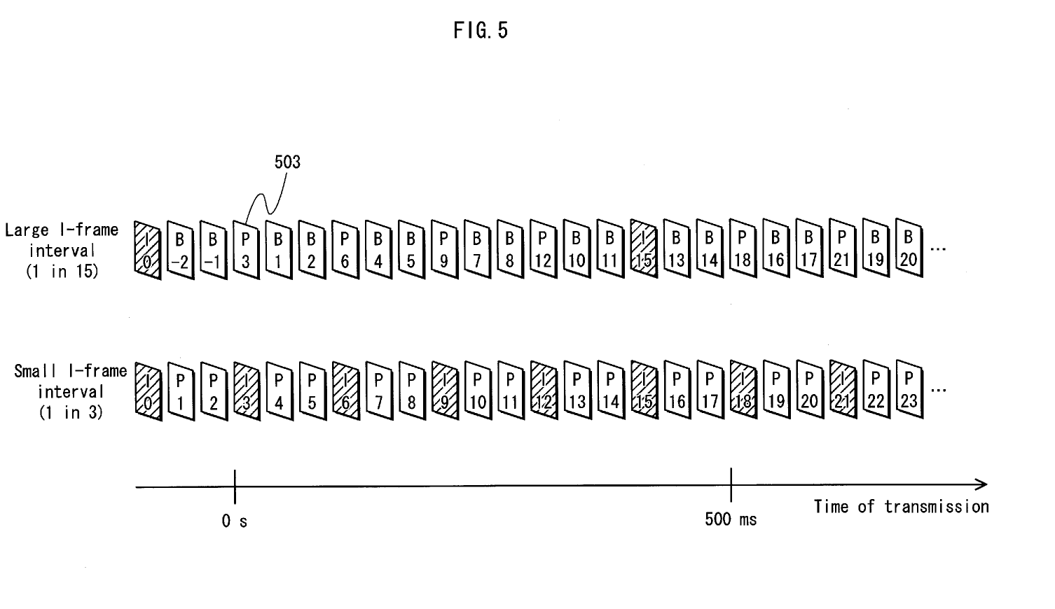

FIG. 5 is a general data structure diagram showing the main video data stream encoded by the encode unit 212. The main video data stream comprises frames that are encoded in the order shown.

In FIG. 5, as in FIG. 4, each rectangle represents a frame. The letters “I”, “P”, and “B” respectively designate each frame as an I-frame, a P-frame, or a B-frame.

Much like in FIG. 4, the number written in each rectangle indicates the order in which each frame is displayed. Where the order in FIG. 4 and in FIG. 5 coincides, the numbers indicate the same frame. For example, the P-frame 503, which is marked “3”, is the same frame as the P-frame 403 in FIG. 4.

As shown in FIG. 5, when the encode unit 212 encodes the digital video data at an I-frame interval that produces a ratio of one I-frame to every 15 frames, the encoding order differs from the order in which the frames are properly decoded and displayed on display A 102. In terms of display order, the encoding order is instead 3-1-2-6-4-5-9 . . . .

If the encode unit 212 receives an interval decrease instruction signal from the instruction reception unit 215 when encoding the digital video data with an

I-frame interval that produces one I-frame to every 15 frames, then the encode unit 212 modifies the I-frame interval so as to produce a ratio of one I-frame to every three frames. If the encode unit 212 receives such a signal when encoding the digital video data with an I-frame interval that produces one I-frame to every three frames, then the encode unit 212 does not modify the I-frame interval.

In addition, if the encode unit 212 receives an interval increase instruction signal from the instruction reception unit 215 when encoding the digital video data with an I-frame interval that produces one I-frame to every three frames, then the encode unit 212 modifies the I-frame interval so as to produce a ratio of one I-frame to every 15 frames. If the encode unit 212 receives such a signal when encoding the digital video data with an I-frame interval that produces one I-frame to every 15 frames, then the encode unit 212 does not modify the I-frame interval.

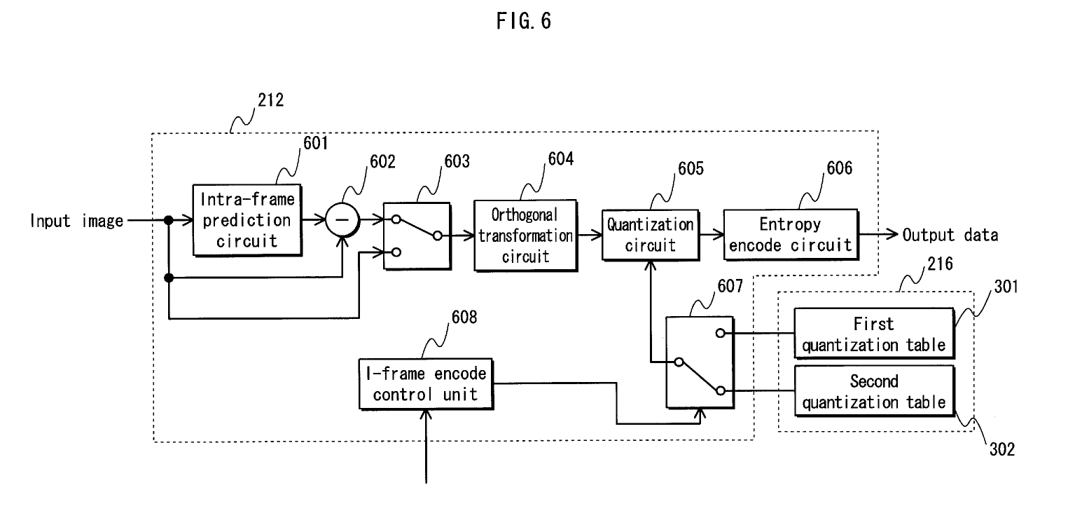

FIG. 6 is an internal configuration diagram of a portion of the encode unit 212. The portion shown covers the generation of I-frames from the input digital video data.

Configuration of portions not involved in I-frame generation is here omitted because such portions are not particularly distinct from widely-known encoding circuits used in encoding methods based on the MPEG4-AVC standard. The following explanations of I-frame generation are focused on areas thought necessary to the description of the present embodiment. Certain portions are thus omitted.

The I-frame generating portion of the encode unit 212 comprises an intra-frame prediction circuit 601, a subtraction circuit 602, a video changeover switch 603, an orthogonal transformation circuit 604, a quantization circuit 605, an entropy encode circuit 606, a table changeover switch 607, and an I-frame encode control unit 608. When the digital video data that is to be encoded as an I-frame is input, these components output as the encoded I-frame.

The intra-frame prediction circuit 601 performs intra-frame prediction at the macroblock (hereinafter abbreviated MB) level on the necessary MBs in the input video data, and then outputs the MB data to the subtraction circuit 602.

MB data refers to a collection of pixel data made up of 16 pixels in a four-by-four matrix of four horizontal pixels by four vertical pixels. The intra-frame prediction circuit 601, the subtraction circuit 602, the orthogonal transformation circuit 604, and the quantization circuit 605 all process data in MB units.

The subtraction circuit 602 compares the predicted MB data output from the intra-frame prediction circuit 601 to the original MB data and generates difference data showing the difference between the two, then outputs this difference data to the video changeover switch 603.

The video changeover switch 603 selects one of either (i) the difference data output from the subtraction circuit 602 or (ii) the MB data in the input video data for which intra-frame prediction is unnecessary, then outputs the selection to the orthogonal transformation circuit 604.

The orthogonal transformation circuit 604 takes the output of the video changeover switch 603 as input. This may be either the MB data or the difference data, and in either case, the input is composed of 16 pixels in a four-by-four matrix of four horizontal pixels by four vertical pixels. The orthogonal transformation circuit 604 performs an orthogonal transformation that transforms discrete functions into frequency components, thus generating a collection of frequency components made up of 16 frequency components in a four-by-four matrix of four horizontal components by four vertical components, then outputs the collection so generated as frequency component data to the quantization circuit 605.

The table changeover switch 607 receives signals from the instruction reception unit 215 via the I-frame encode control unit 608. Then, in accordance with such signals, the table changeover switch 607 selects one of the quantization tables held in the quantization table hold unit 216, namely the first quantization table 301 and the second quantization table 302, and outputs the selection to the quantization circuit 605 for use in I-frame quantization.

If the current output selection is the first quantization table 301 when the table changeover switch 607 receives an encoded size reduction instruction signal from the instruction reception unit 215, then the selection is modified to select the second quantization table 302. If the current output selection is the second quantization table 302 at such a time, then no modification occurs.

Also, if the current output selection is the second quantization table 302 when the table changeover switch 607 receives an encoded size enlargement instruction signal from the instruction reception unit 215, then the selection is modified to select the first quantization table 301. If the current output selection is the first quantization table 301 at such a time, then no modification occurs.

The quantization circuit 605 quantizes the input frequency component data using the quantization table selected through the table changeover switch 607, then outputs the quantized data to the entropy encode circuit 606.

The entropy encode circuit 606 encodes the input quantized data using CABAC (Context-Adaptive Binary Arithmetic Coding) and outputs the data so encoded.

Thus, when the encode unit 212 receives an encoded size reduction instruction signal from the instruction reception unit 215 while performing encoding using the first quantization table 301, the encode unit 212 switches over to the second quantization table 302, which reduces the encoded size of the encoded video data. Also, when the encode unit 212 receives an encoded size enlargement instruction signal from the instruction reception unit 215 while performing encoding using the second quantization table 302, the encode unit 212 switches over to the first quantization table 301, which enlarges the encoded size of the encoded video data.

The input digital video data is ultimately output after encoding by the encode unit 212 as a main video data stream at a data rate that is one of approximately: (1) 4 Mbps if encoded with an I-frame interval that produces one I-frame every 15 frames, (2) 3 Mbps if encoded with an I-frame interval that produces one I-frame every three frames and if the first quantization table 301 is used, or (3) 8 Mbps if encoded with an I-frame interval that produces one I-frame every three frames and if the second quantization table 302 is used.

However, this data rate fluctuates according to such factors as the movement of objects in the image field, as well as the nature and quantity of such objects.

The data transmission unit 213 outputs the input main video data stream from the encode unit 212 to the video data processing device 101 via the network 110.

The sub-encode unit 217 encodes the input digital video data from the image unit 211 using an encoding method based on the MPEG4-AVC standard and outputs the encoded sub-video data stream to the sub-data transmission unit 218.

The input digital video data is ultimately output after encoding by the sub-encode unit 217 as a sub-video data stream at a data rate of approximately 0.25 Mbps.

However, this data rate fluctuates according such factors as the movement of objects in the image field as well as the nature and quantity of such objects.

Also, this data rate is on the order of 1/32 to 1/12 that of the main video data streams encoded by the encode unit 212 using the first quantization table 301.

The sub-data transmission unit 218 sends the input sub-video data stream from the sub-encode unit 217 to the video data processing device 101 via the network 110.

### {Video Data Processing Device}

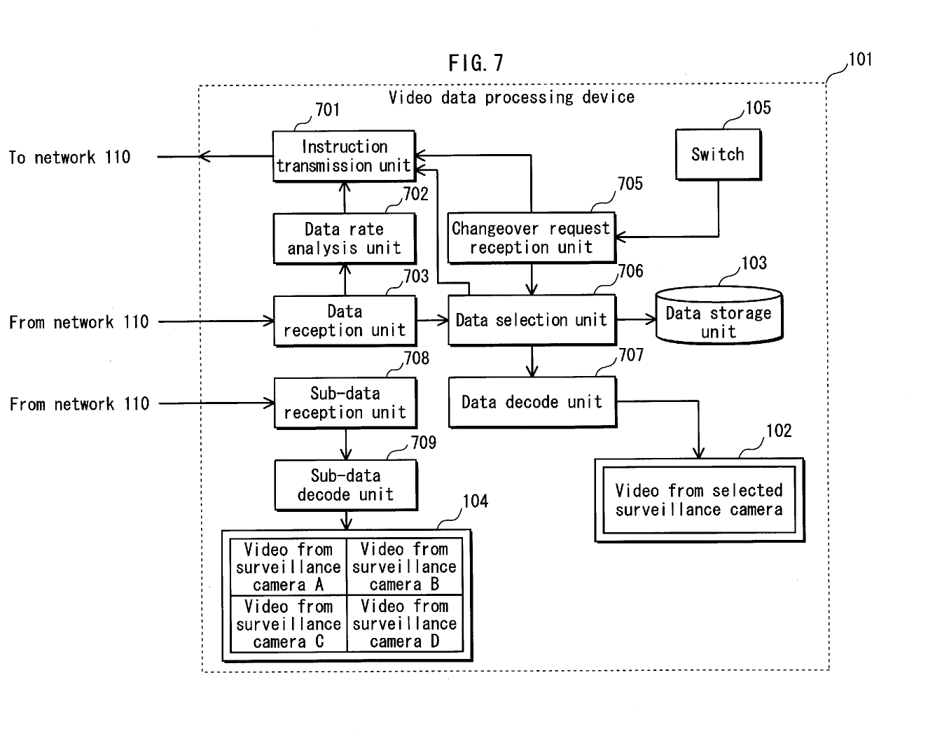

FIG. 7 is a configuration diagram showing the configuration of the video data processing device 101.

The video data processing device 101 comprises an instruction transmission unit 701, a data rate analysis unit 702, a data reception unit 703, a changeover request reception unit 705, a data selection unit 706, a data decode unit 707, the switch 105, the data storage unit 103, display A 102, a sub-data reception unit 708, a sub-data decode unit 709, and display B 104.

The data reception unit 703 receives the main video data stream transmitted via the network 110 from surveillance cameras A 111 through D 114 and outputs same to the data selection unit 706. Also, the data reception unit 703 keeps a cumulative count of the bits of data received, and in doing so, calculates the average received data rate every 100 ms then outputs the result of this calculation to the data rate analysis unit 702.

The data rate analysis unit 702 takes the average received data rate from the data reception unit 703 as input and outputs to the instruction transmission unit 701 (i) an encoded size reduction instruction signal if the average received data rate is, for instance, 40 Mbps or higher, or (ii) an encoded size enlargement instruction signal if the average received data rate is, for instance, 10 Mbps or lower.

The switch 105 can be operated by the user (not diagrammed) in order to change the video footage shown on display A 102 over to the selected video footage from one surveillance camera among surveillance cameras A 111 through D 114.

In response to user operation of the switch 105, the changeover request reception unit 705 outputs an interval decrease instruction signal for the surveillance camera that was selected immediately before the switch 105 was operated, as well as an interval increase instruction signal for the newly selected surveillance camera to the instruction transmission unit 701, and one of a surveillance camera A selection signal, a surveillance camera B selection signal, a surveillance camera C selection signal, or a surveillance camera D selection signal to the data selection unit 706.

Upon input of an encoded size reduction instruction signal from the data rate analysis unit 702, the instruction transmission unit 701 transmits the encoded size reduction instruction signal via the network 110 to any of the surveillance cameras A 111 through D 114 not encoding the main video data stream selected by the data selection unit 706. Also, upon input of an encoded size enlargement instruction signal from the data rate analysis unit 702, the instruction transmission unit 701 transmits the encoded size enlargement instruction signal via the network 110 to any of the surveillance cameras A 111 through D 114 not encoding the main video data stream selected by the data selection unit 706.

Furthermore, upon input of an interval decrease instruction signal for the surveillance camera that was selected immediately before operation of the switch 105 from the changeover request reception unit 705, the instruction transmission unit 701 first waits for input of a changeover completion signal, which is output by the data selection unit 706 to indicate that main video data stream changeover is complete, then transmits an interval decrease instruction signal as well as an encoded size enlargement instruction signal via the network 110 to the surveillance camera in question. Also, upon input of an interval increase instruction signal for the surveillance camera newly selected by operation of the switch 105 from the changeover request reception unit 705, the instruction transmission unit 701 first waits for input of a changeover completion signal from the data selection unit 706, then sends an interval increase instruction signal via the network 110 to the surveillance camera in question.

The data selection unit 706 selects one of the four main video data streams output by the data reception unit 703, and in turn outputs that selection to the data storage unit 103 and to the data decode unit 707. Upon input of a surveillance camera A selection signal from the changeover request reception unit 705, the data selection unit 706 changes the output from the currently-selected main video data stream over to that of surveillance camera A 111 so that the first frame of the main video data stream output after the changeover is an I-frame from surveillance camera A 111.

Similarly, upon receiving a surveillance camera B selection signal, a surveillance camera C selection signal, or a surveillance camera D selection signal, the data selection unit 706 changes the output from the currently-selected main video data stream over to that of surveillance camera B 112, C 113, or D 114, so that the first frame of the main video data stream output after the changeover is an I-frame from surveillance camera B 112, C 113, or D 114.

Also, upon changing the selected main video stream over in this way, the data selection unit 706 outputs a changeover completion signal to the effect that main video data stream changeover is complete to the instruction transmission unit 701.

The data storage unit 103 has a hard disk drive and saves the input main video data stream from the data selection unit 706 thereon.

The data decode unit 707 decodes the input main video data stream from the data selection unit 706 and outputs the stream so decoded to display A 102.

Display A 102 displays the main video data stream decoded by the data decode unit 707.

The sub-data reception unit 708 receives the sub-video data streams transmitted via the network 110 from surveillance cameras A 111 through D 114 and outputs these to the sub-data decode unit 709.

The sub-data decode unit 709 decodes the four sub-video data streams input from the sub-data reception unit and outputs the streams so decoded to display B 104.

Display B 104 simultaneously displays the four sub-video data streams decoded by the sub-data decode unit 709 on a screen divided into quarters.

The above-described structure of the video data processing system 1000 is operated as described below. The explanations that follow describe operations when the user changes the selected video footage on display A 102, as well as operations when fluctuations occur in the data rate received by video data processing device 101.

### (Operations)

### {Outline}

An outline of the operations of the above-described video data processing system 1000 is explained below.

Surveillance cameras A 111 through D 114 each encode footage captured in real time as a main video data stream and a sub-video data stream, and send these streams to the video data processing device 101 via the network 110.

The video data processing device 101 selects one of the four main video data streams from surveillance cameras A 111 through D 114 and, in real time, saves the selected stream to the data storage unit 103 while decoding and displaying this video footage on display A 102. Also, the video data processing device 101 decodes the four sub-video data streams from surveillance cameras A 111 through D 114 in real time and displays these on display B 104.

When the user operates the switch 105 to change the video footage displayed on display A 102 from the footage captured by the currently-selected surveillance camera (hereinafter referred to as the pre-changeover surveillance camera) over to that captured by a new surveillance camera (hereinafter referred to as the post-changeover surveillance camera), an interval decrease instruction signal is output to the pre-changeover surveillance camera, and an interval increase instruction signal as well as an encoded size enlargement instruction signal are output to the post-changeover surveillance camera.

The selected video changeover operation described above decreases the I-frame interval of the main video data streams that may be changed over to next. This is done in order to reduce the waiting time from the reception of a changeover request until the video data processing device 101 can perform the main video data stream changeover.

Furthermore, as the data rate received via the network 110 fluctuates, the video data processing device 101 responds as follows: Given a certain maximum transfer bit rate that the network 110 can handle (such as 50 Mbps), if the current bit rate is one that allows little leeway relative to this maximum (such as 40 Mbps), then the video data processing device 101 outputs an instruction that has the effect of reducing the encoded size of the main video data stream to the three surveillance cameras among surveillance cameras A 111 through D 114 that are not capturing the footage currently displayed on display A 102. If the current bit rate is a low one that leaves plenty of extra capacity relative to the maximum (such as 10 Mbps), then the video data processing device 101 outputs an instruction that has the effect of enlarging the encoded size of the main video data stream to the three surveillance cameras among surveillance cameras A 111 through D 114 that are not capturing the footage currently displayed on display A 102.

The above-described operations in response to received data rate fluctuations are performed in order to ensure that the data rate at which the video data processing device 101 receives data does not exceed the maximum bit rate that the network 110 can handle.

The operations that characterize the video data processing system 1000 of the present Embodiment, namely (1) selected video changeover and (2) response to data rate fluctuations are described in further detail below.

### {Selected Video Changeover}

The operations of the video data processing system 1000 when performing a changeover of the video displayed on display A 102 are described below with reference to the figures.

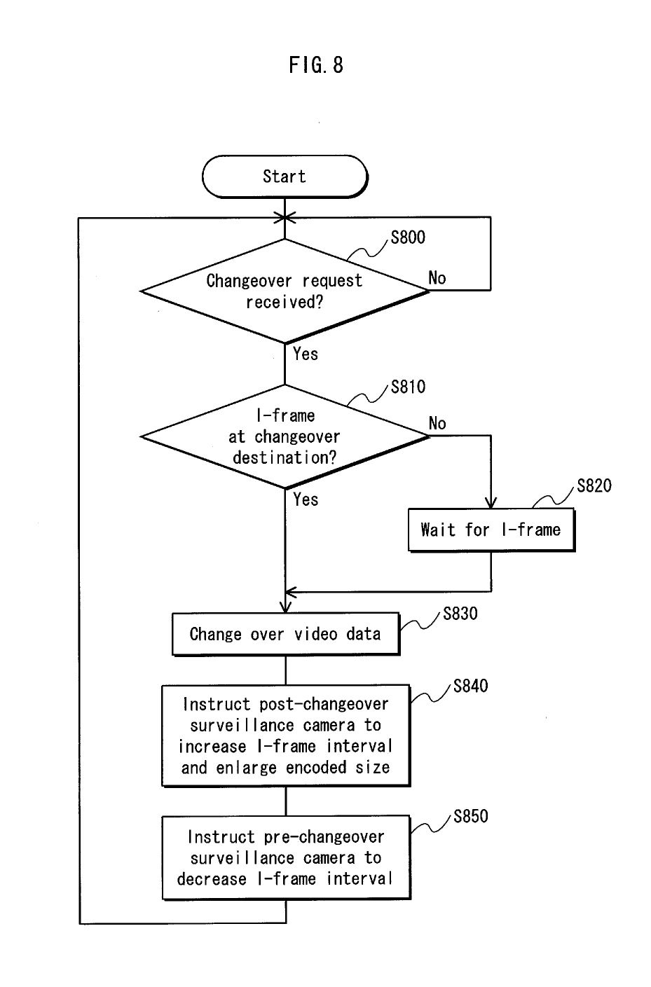

FIG. 8 is a flowchart showing the operations of the video data processing device 101 when performing a changeover of the video displayed on display A 102.

When the user operates the switch 105 so that the video footage displayed on display A 102 is changed from the footage of the pre-changeover surveillance camera over to the footage of the post-changeover surveillance camera, the changeover request reception unit 705 receives a request from the user to such effect (Yes in step S800).

Upon receiving this request, the changeover request reception unit 705 outputs an interval decrease instruction signal for the pre-changeover surveillance camera as well as an interval increase instruction signal for the post-changeover surveillance camera to the instruction transmission unit 701, and also outputs a post-changeover surveillance camera selection signal to the data selection unit 706.

Upon receiving the post-changeover surveillance camera selection signal, the data selection unit 706 investigates whether or not the frame of the main video data stream from the post-changeover surveillance camera sent by the data reception unit is an I-frame (step S810). If so (Yes in step S810), the data selection unit 706 changes the selected main video data stream from that of the pre-changeover surveillance camera to that of the post-changeover surveillance camera (step 830) so that this I-frame becomes the first frame of the main video data stream output after changeover, then outputs a changeover completion signal to the instruction transmission unit 701.

If the frame of the main video data stream from the post-changeover surveillance camera in step S810 is not an I-frame (No in step S810), then the data selection unit 706 changes the selected main video data stream from that of the pre-changeover surveillance camera to that of the post-changeover surveillance camera (step 830) so that the first I-frame input after this frame becomes the first frame of the main video data stream output after the changeover (step S820), and then outputs a changeover completion signal to the instruction transmission unit 701.

At this point, the instruction transmission unit 701 has already received the interval decrease instruction signal for the pre-changeover surveillance camera and the interval increase instruction signal for the post-changeover surveillance camera. Therefore, upon receiving the changeover completion signal from the data selection unit 706, the instruction transmission unit 701 outputs the interval increase instruction signal as well as an encoded size enlargement instruction signal to the post-changeover surveillance camera (step S840) and outputs the interval decrease instruction signal to the pre-changeover surveillance camera (step S850). This is accomplished via the network 110.

If, in step S800, no surveillance camera changeover request has been received (No in step S800), or if step 850 has been completed, then the process returns to S800 and waits until a user operation of the switch 105 produces a surveillance camera changeover request.

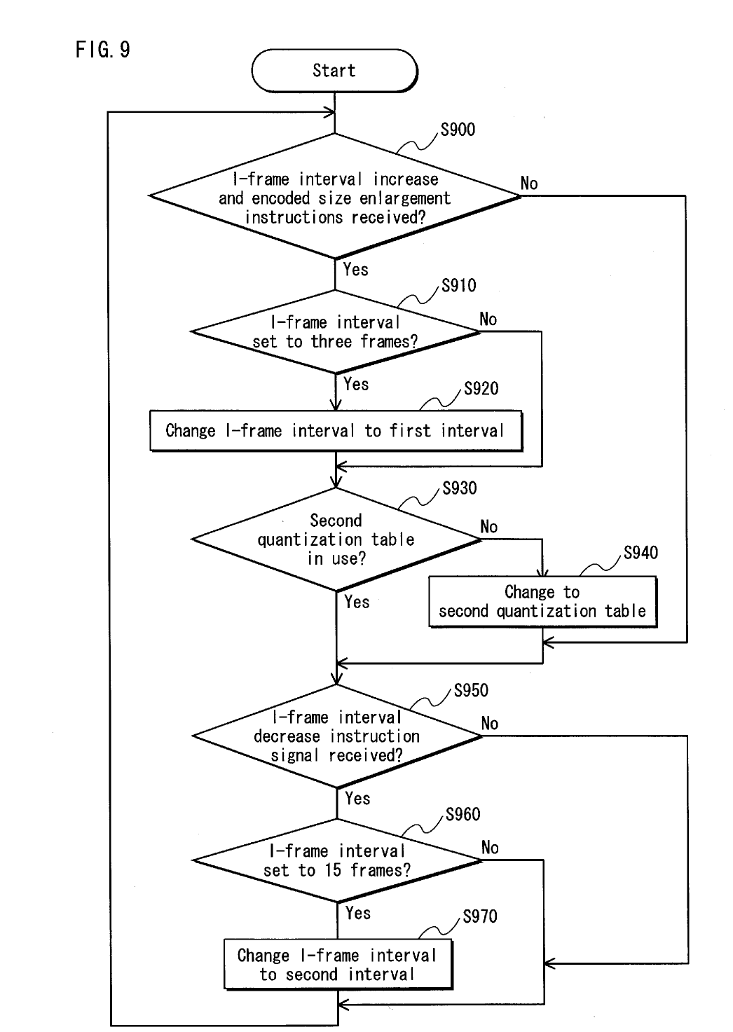

FIG. 9 is a flowchart showing the operations of surveillance camera A 111 when a changeover of the video footage displayed on display A 102 is performed.

Upon receiving the interval increase instruction signal and the encoded size enlargement instruction signal via the network 110 from the video data processing device 101 (Yes in step S900), the instruction reception unit 215 of surveillance camera A 111 outputs the interval increase instruction signal and the encoded size enlargement instruction signal to the encode unit 212.

The encode unit 212 encodes the input digital video data at an I-frame interval that produces an I-frame ratio of either one to every three frames or one to every 15 frames. Upon receiving the interval increase instruction signal and the encoded size enlargement instruction signal, if the I-frame interval is set to produce an I-frame ratio of one to every three frames (Yes in step S910), then the encode unit 212 modifies the I-frame interval to produce an I-frame ratio of one to every 15 frames (step S920). If the I-frame interval is set to produce an I-frame ratio of one to every 15 frames (No in step S910), then the encode unit 212 makes no modification to the I-frame interval.

Furthermore, if the quantization table in use for I-frame encoding is the second quantization table 302 (Yes in step S930), then the encode unit 212 carries on without changing quantization tables. If the quantization table in use for I-frame encoding is the first quantization table 301 (No in step S930), then the encode unit 212 changes from the first quantization table 301 over to the second quantization table 302 (step S940).

If no interval increase instruction signal and encoded size enlargement instruction signal are received in step S900 (No in step S900), or if the quantization table being used for I-frame encoding in step S930 is the second quantization table 302 (Yes in step S930), or else if step S940 has been completed, then upon receiving an interval decrease instruction signal from the video data processing device 101, the instruction reception unit 215 outputs the interval decrease instruction signal to the encode unit 212 via the network 110.

The encode unit 212 encodes the input digital video data at an I-frame interval that produces an I-frame ratio of either one to every three frames or one to every 15 frames. Upon receiving an interval decrease instruction signal, if the I-frame interval is set to produce an I-frame ratio of one to every 15 frames (Yes in step S960), then the encode unit 212 modifies the I-frame interval to produce an I-frame ratio of one to every three frames (step S970). If the I-frame interval is set to produce an I-frame ratio of one to every three frames (No in step S960), then the encode unit 212 makes no modification thereto.

If no interval decrease instruction signal is received in step S950 (No in step S950), or if the I-frame interval in step S960 is set to produce an I-frame ratio of one to every three frames (No in step S960), or else if step S970 has been completed, then the process returns to step S900.

Specific operations in an example case where footage from surveillance camera A 111 is displayed on display A 102 when, at time t1, the user operates the switch 105 so that the footage displayed on display A 102 is changed over to the footage from surveillance camera B 112 are described below with reference to the figures.

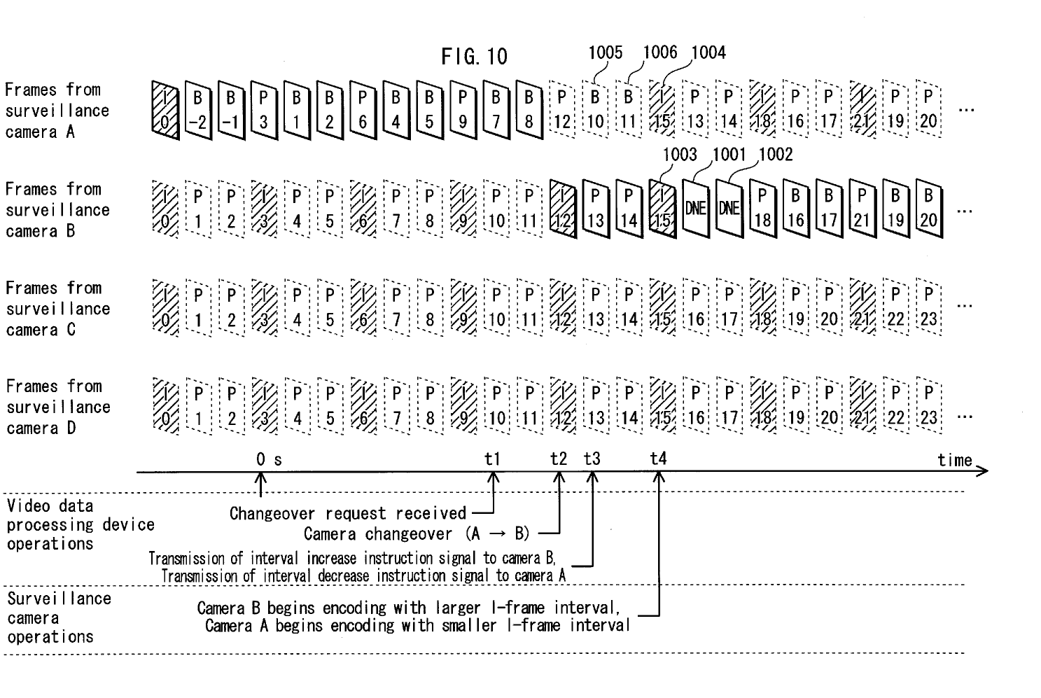

FIG. 10 is a general data structure diagram of the four main video data streams received by the data reception unit 703 in which video footage from surveillance camera A 111 is being displayed on display A 102 when the switch 105 is operated by the user at time t1 so that the footage displayed on display A 102 is switched over to the footage from surveillance camera B 112. As in FIG. 4, each rectangle represents a frame. The letters “I”, “P”, and “B” respectively designate each frame as an I-frame, a P-frame, or a B-frame. The numbers indicate the order in which each frame is decoded and displayed on display A 102.

Additionally, the frames in solid outlines are frames of the main video data stream selected by the data selection unit 706. The frames in segmented outlines are frames of main video data streams not selected by the data selection unit 706.

The main video data stream from surveillance camera A 111, which has been encoded with I-frames quantized using the second quantization table 302, is explained here.

At time 0 s, the data selection unit 706 has selected the main video data stream from surveillance camera A 111. The main video data stream from surveillance camera A 111 has been encoded with an I-frame interval that produces an I-frame ratio of one to every 15 frames. The main video data streams from surveillance cameras B 112, C 113, and D114 have each been encoded with an I-frame interval that produces an I-frame ratio of one to every three frames.

At time 0 s, the user is watching the hotel passageway by looking at the sub-video footage from surveillance cameras A 111 through D 114 displayed at QCIF resolution and quality on four quarters of display B 104.

At this time, the video footage from surveillance camera A 111 is displayed on display A 102, and the main video data stream from surveillance camera A 111 is being saved by the data storage unit 103.

The user sees suspicious movement in the video footage from surveillance camera B 112 displayed on display B 104 and decides to view this footage in improved quality on display A 102. At time t1, the user operates the switch 105 in an attempt to change the video footage displayed on display A 102 from that of surveillance camera A 111 over to that of surveillance camera B 112.

Upon receiving a changeover request to surveillance camera B 112 at time t1 (Yes in step S800), the changeover request reception unit 705 outputs an interval decrease instruction signal for surveillance camera A 111 and an interval increase instruction signal for surveillance camera B 112 to the instruction transmission unit 701, as well as a surveillance camera B selection signal to the data selection unit 706.

Because the frame of the main video data stream from surveillance camera B 112 at time t1 is a P-frame (No in step S810), the data selection unit 706 waits for the span of two frames until time t2. When the first subsequent I-frame is in position, the data selection unit 706 changes the selected main video data stream from that of the pre-changeover surveillance camera over to that of the post-changeover surveillance camera (step S830), and then outputs a changeover completion signal to the instruction transmission unit 701.

At time t2, the data selection unit 706 changes the selected main video data stream over to that of surveillance camera B 112. Therefore, from time t2 onward, the video footage displayed on display A 102 is the footage from surveillance camera B 112 and that footage is also saved by the data storage unit 103.

Upon receiving the changeover completion signal from the data selection unit 706, the instruction transmission unit 701 outputs an interval increase instruction signal and an encoded size enlargement instruction signal to surveillance camera B 112 (step S840) and outputs an interval decrease instruction signal to surveillance camera A 111 (step S850). This is done at time t3 via the network 110.

Upon receiving the interval increase instruction signal and the encoded size enlargement instruction signal via the network 110 (Yes in step S900), the instruction reception unit 215 of surveillance camera B 112 outputs the received signals to the encode unit 212 of surveillance camera B 112.

Upon receiving the interval increase instruction signal and the encoded size enlargement instruction signal (step S900), the encode unit 212 of surveillance camera B 112, which has been encoding with an I-frame interval that produces a ratio of one I-frame to every three frames (Yes in step S910), modifies the I-frame interval to produce a ratio of one I-frame to every 15 frames (step S920) and carries on with encoding (time t4).

Also, until time t4, the encode unit 212 of surveillance camera B 112 uses the second quantization table 302 for I-frame quantization (Yes in step S930) and therefore carries on with encoding using that quantization table from time t4 onward.

The first frame of the main video data stream transmitted to the video data processing device 101 via the network 110 by the data transmission unit 213 of surveillance camera B 112 as of time t4 is the frame 1003.

Frame 1001 and frame 1002, which are the next frames to be transmitted after frame 1003, were originally meant to be B-frame no. 13 and B-frame no. 14, respectively. However, because these frames were both encoded when the I-frame interval was set to produce one I-frame to every three frames, a P-frame no. 13 and a P-frame no. 14 have already been created and transmitted to the data processing device 101.

Accordingly, there is no longer a need to create frame 1001 and frame 1002, and the encode unit 212 of surveillance camera B 112 does not create these frames.

Upon receiving the interval decrease instruction signal via the network 110 (Yes in step S900), the instruction reception unit 215 of surveillance camera A 111 outputs that signal to the encode unit 212 of surveillance camera A 111.

Upon receiving the interval decrease instruction signal (Yes in step S950), the encode unit 212 of surveillance camera A 111, which has been encoding with an I-frame interval that produces a ratio of one I-frame to every 15 frames (Yes in step S960), modifies the I-frame interval to produce a ratio of one I-frame to every three frames (step S970) and carries on with encoding (time t4).

The first frame of the main video data stream transmitted to the video data processing device 101 via the network 110 by the data transmission unit 213 of surveillance camera a 111 as of time t4 is the frame 1004.

Meanwhile, surveillance cameras C 113 and D 114 are encoding video footage with an I-frame interval that produces a ratio of one I-frame to every three frames and sending the footage via the network 110 to the video data processing device 101.

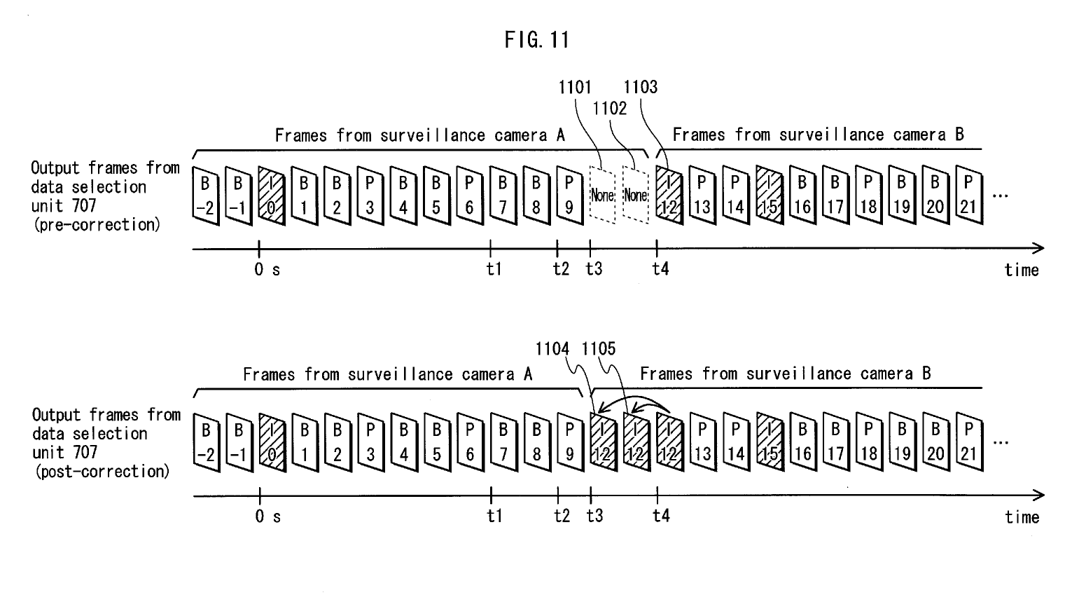

FIG. 11 is a general data structure diagram of the main video data stream encoded by the data decode unit 707. Much like in FIG. 10, each rectangle represents a frame, the letters “I”, “P”, and “B” respectively designate each frame as an I-frame, a P-frame, or a B-frame, and the numbers written therein indicate the order in which each frame is decoded and displayed on display A 102.

The top row of FIG. 11 is a general data structure diagram of the main video data stream decoded by the data decode unit 707 without correction to the output of the data selection unit 706. The bottom row of FIG. 11 is a general data structure diagram of the main video data stream decoded by the data decode unit 707 with corrections (explained later) made to the output of the data selection unit 706.

In the present embodiment, the data selection unit 706 makes corrections to the output thereof.

Without correction, the situation is as follows: frame 1101, which comes three frames after the reception of the changeover request at time t1, and frame 1102, which comes four frames after same, are respectively meant to be frames 1005 and 1006 in the main video data stream of surveillance camera A 111 from FIG. 10. However, because the data selection unit 706 changes the selected main video data stream over to that of surveillance camera B 112 at time t2, frames 1005 and 1006 are not input to the data decode unit 707. Accordingly, the data decode unit 707 cannot decode frame 1005 and frame 1006.

Frames that are not decoded cause disorder in the decoded video footage. For this reason, the data selection unit 706 makes corrections to the output data so that, as shown in the bottom row of FIG. 11, frame 1103, which follows frame 1102 and is included in the main video data stream of surveillance camera B 112, is output as frame 1004 and as frame 1005.

Ultimately, the video footage from the changeover destination surveillance camera B 112 is displayed on display A 102 as of three frames after user operation of the switch 105 at time t1.

### {Received Data Rate Fluctuations}

The operations of the video data processing system 1000 in response to fluctuations in the data rate received by the video data processing device 101 are explained below with reference to the figures.

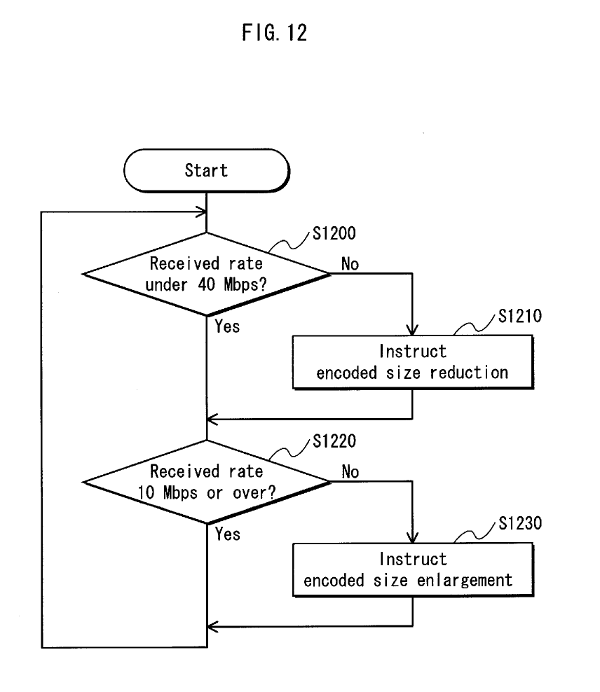

FIG. 12 is a flowchart showing the operations of the video data processing device 101 in response fluctuations in the data rate received thereby.

Every 100 ms, the data rate analysis unit 702 receives the average received data rate output from the data reception unit 703, reflecting data reception thereby.

Upon receiving the average received data rate, the data rate analysis unit 702 determines whether or not the average received data rate is under 40 Mbps (step S1200). If so (Yes in step S1200), then the data rate analysis unit 702 determines whether the average received data rate is equal to or over 10 Mbps (step S1220). If such is the case (Yes in step S1220), then the data rate analysis unit 702 waits for the next average received data rate output from the data reception unit 703.

If the average received data rate is found in step S1200 to be equal to or over 40 Mbps (No in step S1200), then given that such a total transfer rate of data does not allow sufficient leeway relative to the maximum transfer rate of data (50 Mbps) of the network 110, the data rate analysis unit 702 outputs an encoded size reduction instruction signal to the instruction transmission unit 701 (step S1210). The instruction transmission unit 701 then transmits the encoded size reduction instruction signal via the network 110 to surveillance cameras among surveillance cameras A 111 through D 114 that are not encoding the main video data stream selected by the data selection unit 706. The process then continues at step S1220.

If the average received data rate is found in step S1220 to be equal to or under 10 Mbps (No in step S1220), then given that such a total transfer rate of data allows plenty of leeway relative to the maximum data transfer rate (50 Mbps) of the network 110, the data rate analysis unit 702 outputs an encoded size enlargement instruction signal to the instruction transmission unit 701 (step S1230). The instruction transmission unit 701 then transmits the encoded size enlargement instruction signal via the network 110 to surveillance cameras among surveillance cameras A 111 through D 114 that are not encoding the main video data stream selected by the data selection unit 706. The data rate analysis unit 702 then waits for the next average received data rate output from the data reception unit 703.

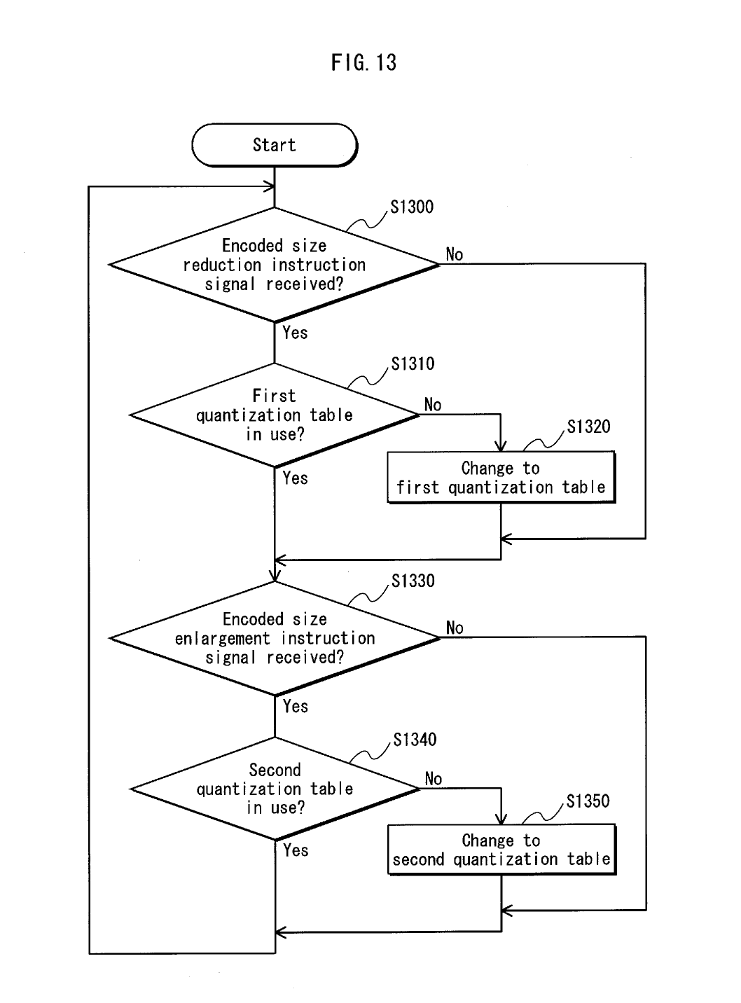

FIG. 13 is a flowchart showing the operations of surveillance cameras A 111 through D 114 when fluctuations occur in the data rate received by the video data processing device 101.

Upon receiving an encoded size reduction instruction signal from the video data processing device 101 via the network 110 (Yes in step S1300), the instruction reception unit 215 outputs that signal to the encode unit 212.

The encode unit 212 investigates whether the quantization table in use for I-frame quantization is the first quantization table 301 (step S1310). If so (Yes in step S1310), the first quantization table 301 remains in use. If the second quantization table 302 is in use (No in step S1310), then the quantization table is modified so that the first quantization table 301 is used for I-frame quantization (step S1320).

If the instruction reception unit 215 receives no encoded size reduction instruction signal in step S1300 (No in step 1300), or if the first quantization table 301 is in use for I-frame quantization by the encode unit 212 (Yes in step 1310), or else if step S1320 has been completed, then the instruction reception unit 215 judges whether or not an encoded size enlargement instruction signal has been received via the network 110 from the video data processing device 101 (step S1330). Upon receiving an encoded size enlargement instruction signal (Yes in step S1330), the instruction reception unit 215 outputs that signal to the encode unit 212.

The encode unit 212 investigates whether the quantization table in use for I-frame quantization is the second quantization table 302 (step S1340). If so (Yes in step S1340), the second quantization table 302 remains in use. If the first quantization table 301 is in use (No in step S1340), then the quantization table is modified so that the second quantization table 302 is used for I-frame quantization (step S1350).

If the instruction transmission unit 215 has not received an encoded size enlargement instruction signal in step S1330 (No in step 1330), or if the quantization table in use for I-frame quantization by the encode unit 212 in step S1340 is the second quantization table 302 (Yes in step 1340), or else if step S1350 has been completed, then the process restarts from step S1300.

Next, the specific operations of the video data processing system 1000 when fluctuations occur in the data rate received by the video data processing device 101 are described below with reference to the figures.

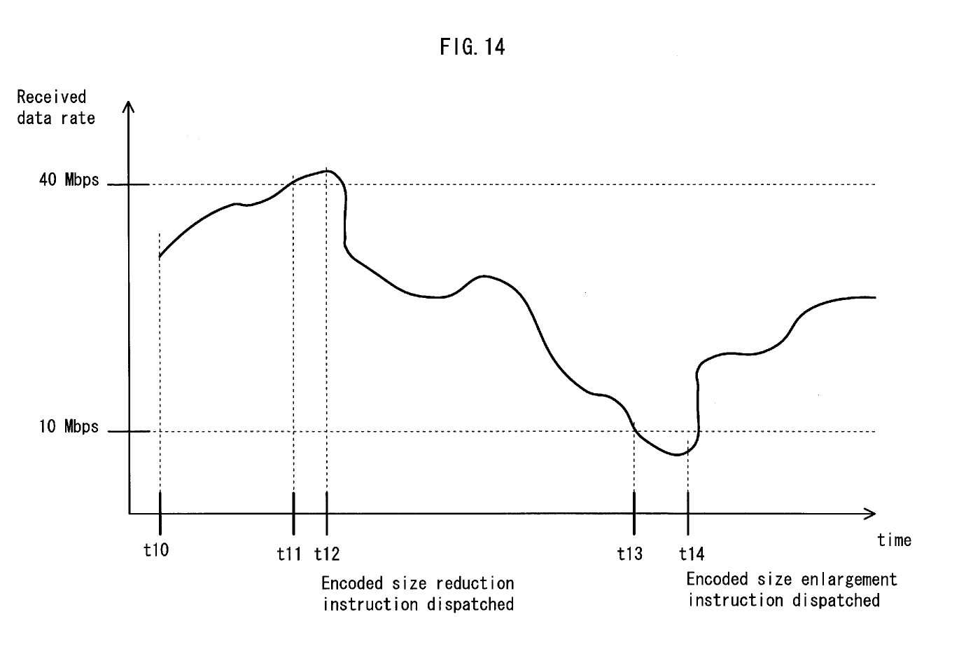

FIG. 14 is a received data rate process diagram showing fluctuations over time in the data rate received by the data reception unit 703.

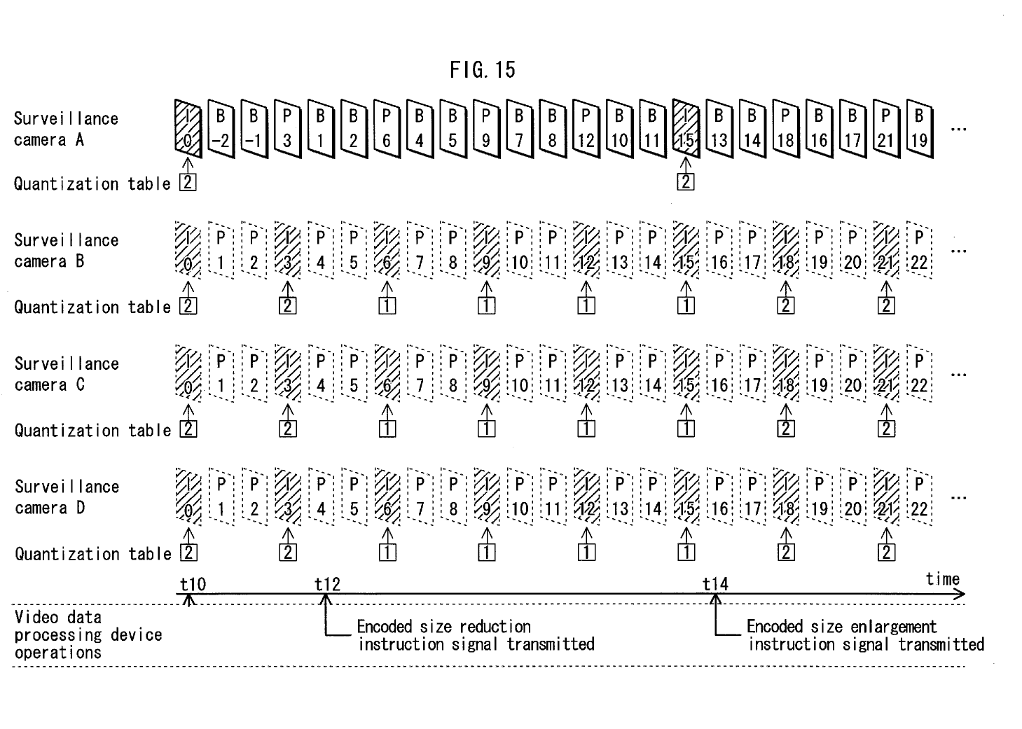

FIG. 15 is a general data structure diagram of the four main video data streams when fluctuations occur in the data rate received by the data reception unit 703 while the video footage from surveillance camera A 111 is displayed on display A 102. As in FIG. 10, each rectangle represents a frame, the letters “I”, “P”, and “B” respectively designate each frame as an I-frame, a P-frame, or a B-frame, and the numbers indicate the order in which each frame is decoded and displayed on display A 102. The frames in solid outlines are frames of the main video data stream selected by the data selection unit 706. The frames in segmented outlines are frames of main video data streams not selected by the data selection unit 706.

Further, the numbers written with arrows below the I-frames indicate the quantization table used to encode the I-frame in question. A “1” indicates the first quantization table 301 and a “2” indicates the second quantization table 302 for I-frame quantization.

As shown in FIG. 14, at time t10, the received data rate is between 10 Mbps and 40 Mbps. Also, as shown in FIG. 15, surveillance cameras B 112, C 113, and D 114 are encoding I-frames using the second quantization table 302.

Next, as shown in FIG. 14, the received data rate gradually goes up from time t10 onward. At time t11, once the received data rate has gone beyond 40 Mbps, the average received data rate received from the data reception unit 703 by the data analysis unit 702 goes above 40 Mbps (No in step S1200). The data analysis unit 702 then outputs an encoded size reduction instruction signal to the instruction transmission unit 701 (step S1210). The instruction transmission unit 701 transmits this signal via the network 110 to surveillance cameras B 112, C 113, and D 114 (time t12).

Once the instruction reception unit 215 of surveillance camera B 112, C 113, and D113 respectively receive the encoded size reduction instruction signal (Yes in step S1300), the encode unit 212 thereof, which has been encoding I-frames using the second quantization table 302, changes the quantization table in use for I-frame quantization from the second quantization table 302 over to the first quantization table 301 (No in step S1310, step S1302) and carries on with encoding.

In other words, as shown in FIG. 15, the I-frames included in the main video data streams of surveillance cameras B 112, C 113, and D 114 are quantized with the second quantization table 302 before time t12, and are quantized with the first quantization table 301 from time t12 onward.

Accordingly, because the encoded size of the main video data streams after time t12 is comparatively smaller than the encoded size thereof before time t12, the received data rate goes down as of time t12. This can be seen in FIG. 14.

Afterward, the received data rate gradually goes down. At time t13, once the received data rate has dropped below 10 Mbps, the average received data rate received from the data reception unit 703 by the data analysis unit 702 falls below 10 Mbps (No in step S1220). The data analysis unit 702 then outputs an encoded size enlargement instruction signal to the instruction transmission unit 701 (step S1230). The instruction transmission unit 701 transmits this signal via the network 110 to surveillance cameras B 112, C 113, and D 114 (time t14).

Once the instruction reception unit 215 of surveillance cameras B 112, C 113, and D113 respectively receive the encoded size enlargement instruction signal (Yes in step S1330), the encode unit 212 thereof, which has been encoding I-frames using the first quantization table 301, changes the quantization table in use for I-frame quantization from the first quantization table 301 over to the second quantization table 302 (No in step S1340, step S1350) and carries on with encoding.

In other words, as shown in FIG. 15, the I-frames included in the main video data streams of surveillance cameras B 112, C 113, and D 114 are quantized with the first quantization table 301 before time t14, and are quantized with the second quantization table 302 from time t14 onward.

Accordingly, because the encoded size of the main video data streams after time t14 is comparatively larger than previously, the received data rate goes up after that time. This can be seen in FIG. 14.

### (Supplement)

This concludes the explanation of the Embodiment of the video data processing system that uses the video data processing device of the present invention in which four surveillance cameras (or, encoding devices) are connected to the video data processing device via a network and make possible hotel passageway surveillance by a user based on the video data received by the video data processing device from the cameras. However, the video data processing device pertaining to the present invention is certainly not limited to the above-described Embodiment. The following variations are also possible.
(1) In the Embodiment, four surveillance cameras A 111 through D 114 were connected to the video data processing device 101 via the network 110. However, the number of surveillance cameras may be other than four.
(2) In the Embodiment, the network 110 performed data transfer through a wired connection. However, a network that transfers data wirelessly or a network that transfers data through a combination of wired and wireless connections may also be used.

For example, if a surveillance camera is set up in a position to which signal wire cannot easily be connected, the network may use a wireless connection for data transfer therewith.
(3) In the Embodiment, the maximum transfer bit rate of the network 110 is 50 Mbps. However, the maximum transfer bit rate may be another value, and may also fluctuate over time.

That said, the upper threshold for the average received data rate, which is the basis for output of the encoded size reduction instruction signal by the data rate analysis unit 702, must be appropriately set. Care must be taken so that the video data processing device 101 does not exceed the maximum transfer bit rate of the network 110. Specifically, if the maximum transfer bit rate fluctuates over time, then the upper threshold for the average received data rate must either be made to fluctuate correspondingly, or be set below the lower limit of such fluctuations.
(4) In the Embodiment, the data rate of the main video data streams output by surveillance cameras A 111 through D 114 is ultimately one of approximately: (1) 4 Mbps if encoded with an I-frame interval that produces one I-frame to every 15 frames, (2) 3 Mbps if encoded with an I-frame interval that produces one I-frame to every three frames and if the first quantization table 301 is used, or (3) 8 Mbps if encoded with an I-frame interval that produces one I-frame to every three frames and if the second quantization table 302 is used. However, encoding may produce data rates other than these.

The greater the encoded size of the main video data stream, the better the image quality of the decoded video. On the other hand, the smaller the encoded size, the lower the bit rate of data transfer for the network 110. Thus, there is a tradeoff between decoded video quality and bit rate. The most appropriate encoded size should be selected with this consideration in mind
(5) In the Embodiment, for each surveillance camera A 111 through D 14, the sub-video data stream is transmitted at a data rate that is on the order of 1/32 to 1/12 that of the main video data stream, and the video data processing device 101 decodes and displays the four received sub-video data streams on display B 104. The structure was explained using an example in which the user operates the switch 105 while watching display B 104. However, the encoded size of the sub-video data streams may be other than the above, and the structure need not involve transmission of the sub-video data streams.

The greater the encoded size of the sub-video data stream, the better the image quality of the decoded video. On the other hand, the smaller the encoded size, the lower the data rate of transfer for the network 110. Thus, there is a tradeoff between decode video quality and bit rate. The most appropriate encoded size should be selected with this consideration in mind.

A possible structure in which the sub-video data streams are not transmitted may, for example, involve infra-red sensors or the like that detect human movement and that are arranged at the location of each surveillance camera. The user may then operate the switch 105 while watching the signals from each infra-red sensor.
(6) In the Embodiment, I-frame quantization is performed using one of two quantization tables, namely the first quantization table 301 and the second quantization table 302. However, quantization may also be performed using one of three or more quantization tables.

The more quantization tables available, the more fine-grained adjustments to the encoded size of the main video data stream can be made. Therefore, the number of quantization tables should be decided according to the required frequency of transfer bit rate adjustments.
(7) In the Embodiment, the quantization steps of each frequency component that compose the quantization tables used for I-frame quantization are as written in the example of FIG. 3. However, other values may be used for the quantization steps of each frequency component.

The values of the quantization steps for each frequency component influence the encoded size and the image quality of the decoded video. The tradeoff between these should be taken into consideration in order to set the most appropriate values.
(8) In the Embodiment, surveillance cameras A 111 through D 114 encode video footage using the MPEG4-AVC encoding standard. However, another encoding standard, such as MPEG2, MPEG4 and the like, may also be used provided that the standard used includes I-frame encoding, allows change the I-frame interval of the encoded video data stream in response to instructions from the video data processing device 101, and allows change the quantization table used for I-frame quantization.

Every encoding standard has characteristics regarding the necessary calculations performed at encode time, the encoded size of data, and the like. Therefore, the encoding standard most appropriate to the system should be selected.
(9) In the Embodiment, surveillance cameras A 111 through D 114 all have the same capabilities. However, cameras with different capabilities may also be used.

For instance, a surveillance camera capturing an area with greater security needs may have better resolution and a greater number of pixels, and thus capture more detailed video footage, than the other surveillance cameras.
(10) In the Embodiment, the I-frame interval of the encoded main video data stream from each surveillance camera A 111 through D 114 is set to produce an I-frame ratio of either one I-frame to every 15 frames or of one I-frame to every three frames, and the frame rate is 30 fps. However, other I-frame intervals and a frame rate other than 30 fps may also be used.

In the main video data stream, the I-frame interval and the frame rate influence the waiting time until the next I-frame comes into position after a selected video changeover, the image quality, and the transfer bit rate of data of the network. Therefore, the tradeoffs between all of these should be kept in mind in order to select the most appropriate combination.
(11) In the Embodiment, the structure is such that the frame rate of the encoded main video data stream from each surveillance camera A 111 through D 114 is fixed at 30 fps. However, a variable frame rate may also be used.

It must be noted that in such a variable-frame-rate structure, there is no ratio of I-frames in the main video data stream, but there is instead a time interval from one I-frame to the next I-frame. By controlling this time interval, the waiting time until the first I-frame appears after a main video data stream changeover request is received can in turn be controlled.
(12) In the Embodiment, the video data processing device 101 transmits encoded size reduction instruction signals and encoded size enlargement instruction signals to all surveillance cameras not encoding the main video data stream selected by the data selection unit 706. However, these signals may instead be transmitted to a subset of surveillance cameras not encoding the main video data stream selected by the data selection unit 706.

For instance, an encoded size reduction instruction signal or an encoded size enlargement instruction signal may be transmitted to a selected surveillance camera that transmits the main video data stream with the highest data rate.

The number of main video data streams in which the decoded video drops in quality can thus be kept low while allowing control of the encoded size thereof received by the video data processing device 101.
(13) In the Embodiment, the data reception unit 703 calculates the average received data rate every 100 ms and outputs the rate so calculated to the data rate analysis unit 702. However, the average received data rate may be calculated and output to the data rate analysis unit 702 at a pace other than once every 100 ms.

If the average received data rate is calculated at more frequent intervals, then the average received data rate will reflect more minute changes in the received data rate. As such, if faster responses to received data rate fluctuations are necessary, then setting a shorter average received data rate calculation interval is suggested.
(14) Further structures for the video data processing device pertaining to the Embodiment of the present invention, as well variations thereof and their effects, are explained below.
(a) The video data processing device pertaining to the Embodiment of the present invention comprises a data reception unit operable to receive encoded data streams that include I-frames and that are transmitted in parallel from a plurality of encoding devices that encode and transmit video data, a selection unit operable to select and output one of the encoded data streams received in parallel by the data reception unit, an interval instruction unit operable, when the selected encoded data stream is changed from a first encoded data stream over to a second encoded data stream, to instruct an encoding device that encodes and transmits the first encoded data stream to begin encoding with a smaller I-frame time interval than that previously used thereby, and to instruct an encoding device that encodes and transmits the second encoded data stream to begin encoding with a larger I-frame time interval than that previously used thereby, and a data size instruction unit operable, when a size per unit time of data received by the data reception unit is above an upper threshold, to instruct any one or more of the encoding devices transmitting non-selected encoded data streams to change a quantization table currently in use for I-frame quantization over to a quantization table for which an encoded size of video data encoded therewith is smaller than that of the quantization table currently in use.

According to the above structure, the video data processing device is able to instruct the encoding devices that may be switched to next to reduce the time interval of the I-frames in the encoded data streams thereof.

This has the effect of reducing the waiting time required for the next I-frame to come into position in the post-changeover data stream, which is necessary before decoding of the encoded data stream can properly begin.

Furthermore, when the data size received per unit time exceeds an upper threshold, the encoding devices can be instructed to change the quantization table in use for I-frame quantization over to a quantization table that gives a smaller encoded size.

For this reason, the upper threshold should be set below the maximum data transfer rate of the network that transmits the encoded data streams. This has the effect of suppressing transfer bit rate increases so that the network transfer bit rate does not exceed the maximum data transfer rate.

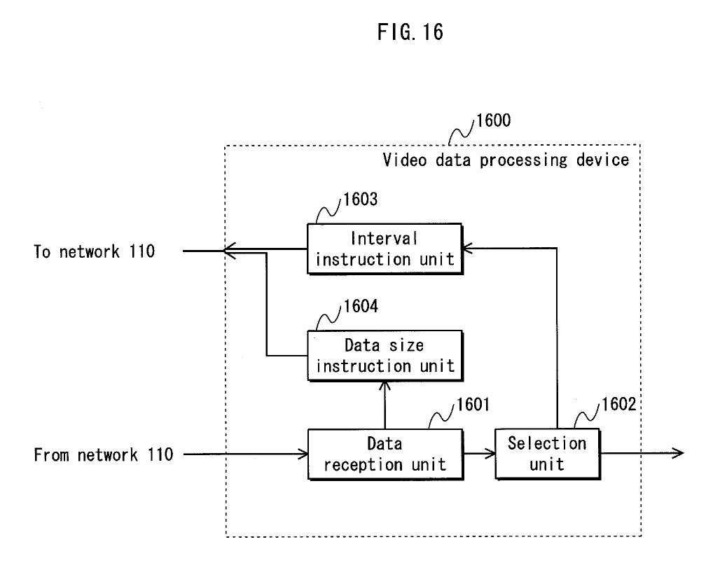

FIG. 16 is a functional structure diagram of the video data processing device 1600 with the above-described variations.

As shown, the video data processing device 1600 comprises a data reception unit 1601, a selection unit 1602, a data size instruction unit 1603, and an interval instruction unit 1604, and is connected via the network 110 to surveillance cameras A 111 through D 114.

The data reception unit 1601, connected to the network 110, the selection unit 1602, and the data size instruction unit 1604, receives encoded data streams that contain I-frames via the network 110 from surveillance cameras A 111 through D 114 in parallel. These surveillance cameras are a group of encoding devices that encode as well as transmit video data.

An example of the data reception unit 1601 can be seen in the data reception unit 703 (see FIG. 7) of the Embodiment.

The selection unit 1602, connected to the data reception unit 1601 and the interval instruction unit 1603, selects and outputs one encoded data stream among the encoded data streams received in parallel by the data reception unit 1601.

An example of the selection unit 1602 can be seen in the data selection unit 706 of the Embodiment.

The interval instruction unit 1603 is connected to the network 110 and the selection unit 1602. When the selection unit 1602 changes the selected encoded data stream from the first encoded data stream over to the second encoded data stream, the interval instruction unit 1603 can instruct the encoding device encoding the first encoded data stream to change over to an I-frame time interval that is shorter than the one in use pre-changeover, and instruct the encoding device encoding the second encoded data stream to change over to an I-frame time interval that is longer than the one in use pre-changeover.

An example of the interval instruction unit 1603 is realized as the instruction transmission unit 701, a portion of the data selection unit 706, and the changeover request reception unit 705 of the Embodiment.

The data size instruction unit 1604 is connected the network 110 and to the data reception unit 1601. When the data size per unit time received by the data reception unit 1601 goes above an upper threshold, the data size instruction unit 1604 instructs at least one of the encoding devices that are transmitting encoded data streams not selected by the selection unit 1602 to change the quantization table in use for I-frame quantization over to a quantization table that produces a smaller encoded size than that produced pre-changeover.

An example of the data size instruction unit 1604 is realized as a portion of the instruction transmission unit 701 and as the data rate analysis unit 702 of the Embodiment.
(b) Additionally, when the size per unit time of data received by the data reception unit is below a lower threshold, the data size instruction unit may instruct any one or more of the encoding devices transmitting the non-selected encoded data streams to change the quantization table currently in use for I-frame quantization over to a quantization table for which the encoded size of video data encoded therewith is larger than that of the quantization table currently in use.

Accordingly, when the data size received per unit time is below a lower threshold, the encoding devices can be instructed to change the quantization table in use for I-frame quantization over to a quantization table that produces a larger encoded size than that produced pre-changeover. Thus, if there is leeway in the transfer bit rate of the network that transmits the encoded data streams with respect to the maximum data transfer rate, the encoded size of the data streams transmitted by the encoding devices is made bigger. In other words, the result is encoded data streams with enhanced image quality.
(c) Also, when the size per unit time of data received by the data reception unit is above the upper threshold, the data size instruction unit may instruct any encoding device transmitting data of the largest size per unit time among the one or more encoding devices transmitting the non-selected encoded data streams to change the quantization table currently in use for I-frame quantization over to the quantization table for which the encoded size of video data encoded therewith is smaller than that of the quantization table currently in use.

Accordingly, the encoding device transmitting data of the largest size per unit time can be instructed to change the quantization table in use for I-frame quantization over to a quantization table that produces a smaller encoded size than that produced pre-changeover. Thus, the transfer bit rate of the network that transmits the encoded data streams remains below to the maximum data transfer rate, and the encoded size of the data streams transmitted by the encoding devices is effectively prevented from growing.
(d) Also, the selection unit, when changing the selected encoded data stream over to a third encoded data stream, may perform changeover with such timing that a first frame output thereafter is one of the I-frames included in the third encoded data stream.

Accordingly, when a selected encoded data stream changeover is performed, the first post-changeover frame is an I-frame. Given that I-frames can be decoded without using information from other frames, the effect is such that frames which cannot be correctly decoded are not present in the post-changeover encoded data stream.
(e) Also, when the selection unit changes the selected encoded data stream from the first encoded data stream over to the second encoded data stream, the data size instruction unit may instruct the encoding device transmitting the second encoded data stream to change the quantization table currently in use over to a quantization table for which an encoded size of video data encoded therewith is larger than that of the quantization table currently in use.

Accordingly, the encoded data stream transmitted by the newly-selected encoding device has a larger encoded size. In other words, this results in improved image quality for the encoded data stream.

### INDUSTRIAL APPLICABILITY

The present invention has wide applications to systems that use multiple encoded video data streams, such as surveillance camera systems.

### REFERENCE SIGNS LIST

101 video data processing device
102 display A
103 data storage unit
104 display B
701 instruction transmission unit
702 data rate analysis unit
703 data reception unit
705 changeover request reception unit
706 data selection unit
707 data decode unit
708 sub-data reception unit
709 sub-data decode unit

1. A video data processing device, comprising:
a data reception unit operable to receive encoded data streams that include I-frames and that are transmitted in parallel from a plurality of encoding devices that encode and transmit video data;
a selection unit operable to select and output one of the encoded data streams received in parallel by the data reception unit;
an interval instruction unit operable, when the selected encoded data stream is changed from a first encoded data stream over to a second encoded data stream, to instruct an encoding device that encodes and transmits the first encoded data stream to begin encoding with a smaller I-frame time interval than that previously used thereby, and to instruct an encoding device that encodes and transmits the second encoded data stream to begin encoding with a larger I-frame time interval than that previously used thereby; and
a data size instruction unit operable, when a size per unit time of data received by the data reception unit is above an upper threshold, to instruct any one or more of the encoding devices transmitting non-selected encoded data streams to change a quantization table currently in use for I-frame quantization over to a quantization table for which an encoded size of video data encoded therewith is smaller than that of the quantization table currently in use.

2. The video data processing device of claim 1, wherein
when the size per unit time of data received by the data reception unit is below a lower threshold, the data size instruction unit instructs any one or more of the encoding devices transmitting the non-selected encoded data streams to change the quantization table currently in use for I-frame quantization over to a quantization table for which the encoded size of video data encoded therewith is larger than that of the quantization table currently in use.

3. The video data processing device of claim 1, wherein
when the size per unit time of data received by the data reception unit is above the upper threshold, the data size instruction unit instructs any encoding device transmitting data of the largest size per unit time among the one or more encoding devices transmitting the non-selected encoded data streams to change the quantization table currently in use for I-frame quantization over to the quantization table for which the encoded size of video data encoded therewith is smaller than that of the quantization table currently in use.

4. The video data processing device of claim 1, wherein
the selection unit, when changing the selected encoded data stream over to a third encoded data stream, performs changeover with such timing that a first frame output thereafter is one of the I-frames included in the third encoded data stream.

5. The video data processing device of claim 1, wherein
when the selection unit changes the selected encoded data stream from the first encoded data stream over to the second encoded data stream, the data size instruction unit instructs the encoding device transmitting the second encoded data stream to change the quantization table currently in use over to a quantization table for which an encoded size of video data encoded therewith is larger than that of the quantization table currently in use.

6. A video data processing system made up of a plurality of encoding devices and the video data processing device of claim 1 configurable to exchange data with the plurality of encoding devices,
each of the encoding devices comprising:
an encode unit operable to encode video data into encoded data streams that include I-frames;
an instruction reception unit operable to receive instructions from the video data processing device; and
a transmission unit operable to transmit the encoded data streams encoded by the encode unit to the video data processing device, wherein
the encode unit performs the following (i) and (ii) in accordance with the instructions received by the instruction reception unit from the video data processing device: (i) modification of an I-frame time interval for the encoded data streams, and (ii) changeover of a quantization table currently in use for I-frame quantization.

7. The video data processing system of claim 6, wherein
the encode unit comprises a plurality of quantization tables for use in I-frame quantization,
use of each of the quantization tables for encoding the video data into the encoded data streams results in a different encoded size thereof, and
upon receipt by the instruction reception unit of an instruction from the video data processing device to change the quantization table currently in use for I-frame quantization over to a quantization table for which an encoded size of video data encoded therewith is smaller than that of a quantization table currently in use,
when a high-compression quantization table for which an encoded size of video data encoded therewith is smaller than that of the quantization table currently in use is present among the plurality of quantization tables for use in I-frame quantization, the encode unit changes the quantization table currently in use over to the high-compression quantization table.

8. The video data processing system of claim 7, wherein
when the size per unit time of data received by the data reception unit is below a lower threshold, the data size instruction unit instructs any one or more of the encoding devices among encoding devices transmitting non-selected encoded data streams to change a quantization table currently in use for I-frame quantization over to a quantization table for which an encoded size of video data encoded therewith is larger than that of the quantization table currently in use, and
if the data reception unit receives an instruction from the video data processing device to change the quantization table currently in use for I-frame quantization over to a quantization table for which an encoded size of video data encoded therewith is larger than that of the quantization table currently in use,
then when a low-compression quantization table for which an encoded size of video data encoded therewith is larger than that of the quantization table currently in use for encoding the video data is present among the plurality of quantization tables for use in I-frame quantization, the encode unit changes the quantization table currently in use for I-frame quantization over to the low-compression quantization table.
